(19) United States
(12) Patent Application Publication
(10) Pub. No.: US 2026/0044400 A1
(43) Pub. Date: Feb. 12, 2026

(54) POWER STATE MANAGEMENT

(71) Applicant: QUALCOMM Incorporated, San Diego, CA (US)

(72) Inventors: Mustafa KESKIN, San Diego, CA (US); Guoqing MIAO, San Diego, CA (US)

(21) Appl. No.: 18/796,168

(22) Filed: Aug. 6, 2024

(51) Int. Cl. G06F 11/07; G06F 1/28

(52) U.S. Cl. CPC G06F 11/076; G06F 1/28; G06F 11/0739

(57) ABSTRACT

Aspects of the disclosure are directed to power state management and diagnostics. In accordance with one aspect, the disclosure includes a neural network (NN) module configured to process a plurality of vectorized channel samples and to generate a plurality of power supply fault predictions; and a vectorization module coupled to the NN module, the vectorization module configured to vectorize a plurality of windowed channel samples and to generate the plurality of vectorized channel samples.

### TECHNICAL FIELD

This disclosure relates generally to the field of electronics, in particular, to power state management and diagnostics in a computing system.

### BACKGROUND

An information processing system, for example, a computer, may require high reliability for management and control of critical functions. A power fault in an electronic subsystem (e.g., an automotive subsystem) may result in a major safety issue. Thus, improved diagnostics and fault response are desirable capabilities for power state management in electronics.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides power state management and diagnostics. Accordingly, the present disclosure discloses an apparatus including: a neural network (NN) module configured to process a plurality of vectorized channel samples and to generate a plurality of power supply fault predictions; and a vectorization module coupled to the NN module, the vectorization module configured to vectorize a plurality of windowed channel samples and to generate the plurality of vectorized channel samples.

In one example, the apparatus further includes an apodizer coupled to the vectorization module, the apodizer configured to time window a plurality of interpolated channel samples and to generate the plurality of windowed channel samples. In one example, the time window is weighted.

In one example, the apparatus further includes an interpolator coupled to the apodizer, the interpolator configured to interpolate a plurality of digital channel samples and to generate the plurality of interpolated channel samples of a reconstructed waveform. In one example, the apparatus further includes an analog to digital converter (ADC) coupled to the interpolator, the ADC configured to digitize one of a plurality of power supply channels and to generate the plurality of digital channel samples based on a triggered event. In one example, the apparatus further includes a multiplexer coupled to the ADC, the multiplexer configured to multiplex the plurality of power supply channels from a plurality of automotive subsystems.

Another aspect of the disclosure provides a method including: performing a neural network (NN) processing on a plurality of vectorized channel samples to generate a plurality of power supply fault predictions; and vectorizing a plurality of windowed channel samples to generate the plurality of vectorized channel samples.

In one example, the plurality of power supply fault predictions includes one or more of the following: a prediction of power supply overvoltage, a prediction of power supply undervoltage, a prediction of power supply overcurrent, a prediction of power supply undercurrent, a prediction of power supply temperature violation, or a prediction of power supply battery depth of discharge (DoD) violation. In one example, the plurality of power supply fault predictions includes one or more of the following: an electrostatic discharge (ESD) event, a power supply glitch, or a power supply line fault. In one example, the plurality of power supply fault predictions includes at least one occurrence statistic of fault events in a power supply.

In one example, the method further includes time windowing a plurality of interpolated channel samples to generate the plurality of windowed channel samples. In one example, the method further includes interpolating a plurality of digital channel samples to generate the plurality of interpolated channel samples of a reconstructed waveform. In one example, the reconstructed waveform includes an estimated frequency based on a counter measurement of one or more detected peaks of the plurality of digital channel samples. In one example, the reconstructed waveform includes an estimated peak amplitude level.

In one example, the method further includes digitizing one of a plurality of power supply channels to generate the plurality of digital channel samples based on a triggered event. In one example, the method further includes multiplexing the plurality of power supply channels from a plurality of electronic subsystems. In one example, the plurality of electronic subsystems is a plurality of automotive subsystems.

Another aspect of the disclosure provides a non-transitory computer-readable medium storing computer executable code, operable on a device including at least one processor and at least one memory coupled to the at least one processor, wherein the at least one processor is configured to implement power state management and diagnostics, the computer executable code including: instructions for causing a computer to perform a neural network (NN) processing on a plurality of vectorized channel samples; instructions for causing the computer to generate a plurality of power supply fault predictions; instructions for causing the computer to vectorize a plurality of windowed channel samples; and instructions for causing the computer to generate the plurality of vectorized channel samples.

In one example, the non-transitory computer-readable medium further includes: instructions for causing the computer to time window a plurality of interpolated channel samples; instructions for causing the computer to generate the plurality of windowed channel samples; instructions for causing the computer to interpolate a plurality of digital channel samples; and instructions for causing the computer to generate the plurality of interpolated channel samples of a reconstructed waveform.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example illustration of an automotive integrated circuit (IC) utilization.

FIG. 3 illustrates an example battery operational state diagram.

FIG. 4 illustrates an example battery power keeper state diagram.

FIG. 5 illustrates an example mixed signal/digital overvoltage tracker circuit.

FIG. 6 illustrates an example analog overvoltage tracker circuit.

FIG. 7 illustrates an example electrostatic discharge (ESD)/clamp circuit.

FIG. 8 illustrates an example power state management system.

FIG. 9 illustrates an example voltage transient graph during a temporary load attack.

FIG. 10 illustrates an example voltage fault graph during a voltage fault.

FIG. 11 illustrates an example system with an event tracker circuit and a state of power keeper (SoP-K) neural network (NN) module.

FIG. 12 illustrates an example flow diagram for implementing power state management and diagnostics.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

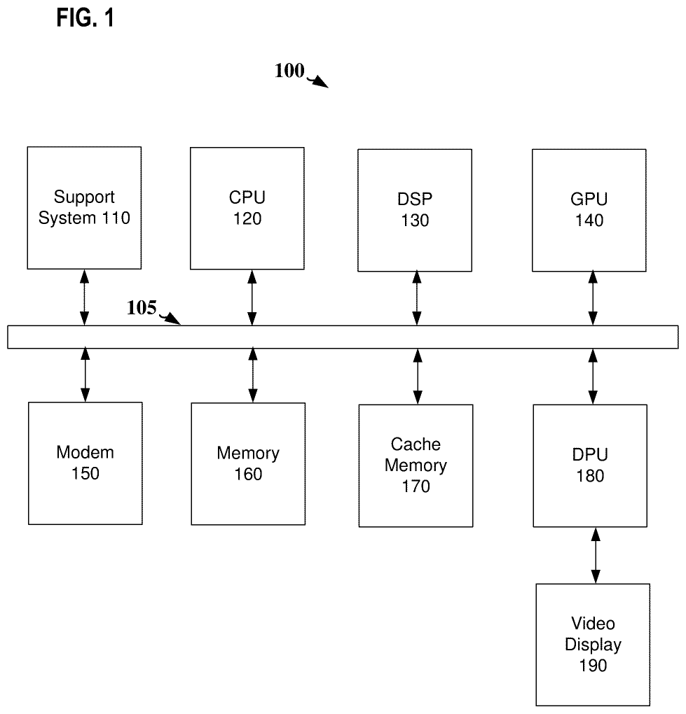

FIG. 1 illustrates an example information processing system 100. In one example, the information processing system 100 includes a plurality of processing engines, or processor cores, such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. For example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines.

In one example, a loss of power (i.e., a power collapse) during an automotive operation, may be a serious fault condition in an automobile, particularly for an electric vehicle (EV). One example of an automotive power fault is a connection fault between an energy source, such as a battery, and an engine. Occurrences of such an automotive power fault may adversely impact automotive sales especially the EV market since an EV relies heavily on automotive electronics using integrated circuits (ICs).

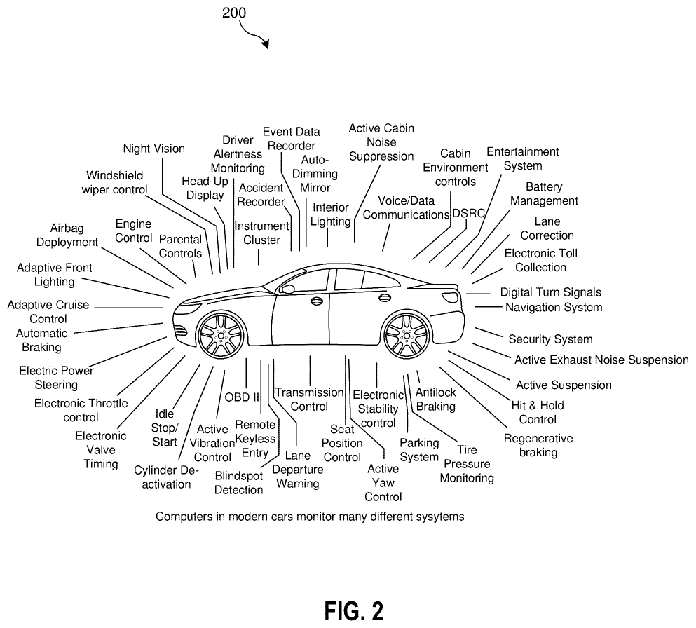

FIG. 2 illustrates an example illustration 200 of an automotive integrated circuit (IC) utilization. As shown, automotive electronics including automotive computing systems monitor and control many different automotive subsystems. For example, automotive subsystems under electronic control include an engine, powertrain, transmission, braking, body, suspension, power steering, battery, etc. In one example, an automobile uses a large quantity of automotive ICs (e.g., automotive chipsets). As a consequence, reliability and fault protection of automotive ICs is critical. In one example, automotive IC reliability requirements in terms of failure probability have evolved from approximately 10 parts per million (10 ppm) to approximately 10 parts per billion (ppb).

In one example, an automotive IC component, a battery or board (e.g., printed circuit board) connections may degrade due to physical environmental stresses such as electromigration, temperature, excessive voltage, excessive current, etc. In one example, IC layout and manufacturing are not perfectly repeatable over multiple production runs which results in a statistical variation in component tolerances. For example, component tolerance statistical variation may be characterized by a process standard deviation (e.g., sigma) which quantifies a variation from a mean value of a process. In one example, lifetime of chipsets and components may be improved by usage of a tracking and prediction mechanism to mitigate IC failures and damages.

In one example, a power state management system (e.g., battery management system) maintains battery voltage and battery current within a nominal operational region which is functionally safe. In one example, the nominal operational region is defined by a maximum battery voltage, a minimum battery voltage, a maximum battery current and a minimum battery current. In one example, the power state management system performs monitoring, prediction, protection and reporting of the battery health. In one example, prediction is performed to estimate an operational state of the battery, where the operational state includes battery voltage and battery current.

In one example, the power state management system responds to a battery fault condition by generating a system alert to restore the battery into its nominal operational region. In one example, the power state management system senses a peak battery current value and responds by reducing available battery current or by an operational interrupt. In one example, the power state management system monitors the battery voltage and may reduce or halt battery charging during a battery charging cycle or may remove electrical loads or limit battery discharge current during a battery discharging cycle. In one example, the power state management system measures a battery temperature and enables a cooling mechanism using battery voltage throttling or frequency throttling.

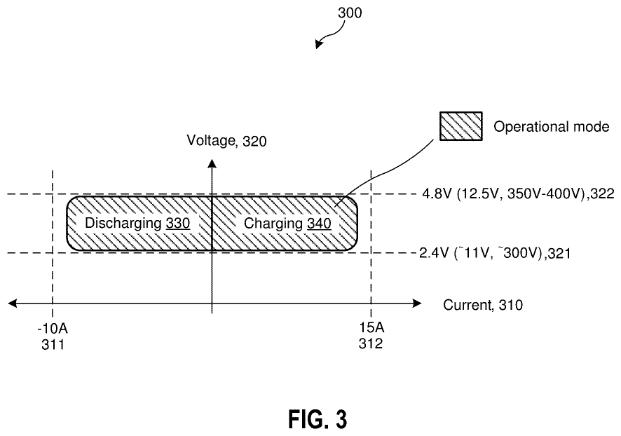

FIG. 3 illustrates an example battery operational state diagram 300. In one example, the battery operational state diagram 300 includes a horizontal axis for battery current 310 and a vertical axis for battery voltage 320. In one example, the horizontal axis for battery current 310 is partitioned into a minimum battery current level 311 and a maximum battery current level 312. In one example, the vertical axis for battery voltage 320 is partitioned into a minimum battery voltage level 321 and a maximum battery voltage level 322. In one example, the nominal operational region is defined by boundaries set by the minimum battery current level 311, the maximum battery current level 312, the minimum battery voltage level 321 and the maximum battery voltage level 322. In one example, the battery operational state diagram 300 shows a battery discharging region 330 within the nominal operational region with negative battery current levels (i.e., less than zero amperes) and a battery charging region 340 within the nominal operational region with positive current levels (i.e., greater than zero amperes). One skilled in the art would understand that the values of the max, min current and max, min voltage are examples and that other such values for particular applications and/or usage are also within the scope and spirit of the present disclosure.

In one example, an automotive power state management system may be used as an intelligent battery monitoring system for EVs. In one example, the automotive power state management system may operate offline, without need for external support from network servers, using a system on a chip (SOC)-based architecture.

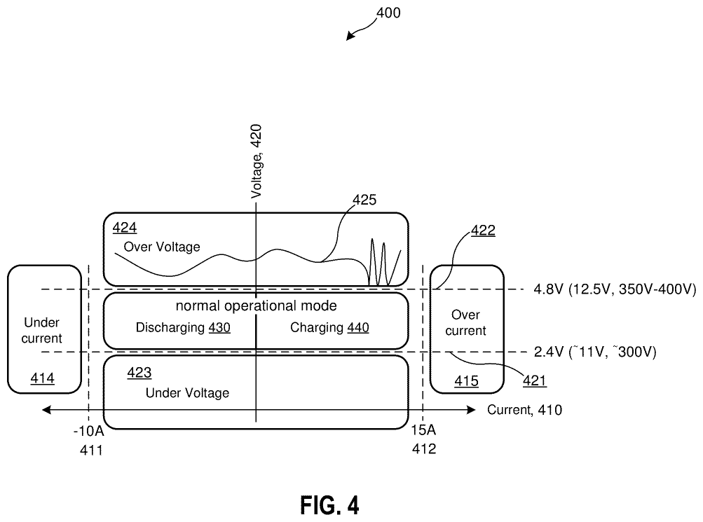

FIG. 4 illustrates an example battery power keeper state diagram 400. In one example, the battery power keeper state diagram 400 includes a horizontal axis for battery current 410 and a vertical axis for battery voltage 420. In one example, the horizontal axis for battery current 410 is partitioned into a minimum battery current level 411 and a maximum battery current level 412. In one example, the vertical axis for battery voltage 420 is partitioned into a minimum battery voltage level 421 and a maximum battery voltage level 422. In one example, the nominal operational region is defined by boundaries set by the minimum battery current level 411, the maximum battery current level 412, the minimum battery voltage level 421 and the maximum battery voltage level 422. One skilled in the art would understand that the values of the max, min current and max, min voltage are examples and that other such values for particular applications and/or usage are also within the scope and spirit of the present disclosure.

In one example, the battery power keeper state diagram 400 shows a battery discharging region 430 within the nominal operational region with negative battery current levels (i.e., less than zero amperes) and a battery charging region 440 within the nominal operational region with positive current levels (i.e., greater than zero amperes). In one example, the battery power keeper state diagram 400 shows an undercurrent region 414 where the battery current is less than the minimum battery current level 411 and an overcurrent region 415 where the battery current is greater than the maximum battery current level 412. In one example, the batter power keeper state diagram 400 shows an undervoltage region 423 where the battery voltage is less than the minimum battery voltage level 421 and an overvoltage region 424 where the battery voltage is greater than the maximum battery voltage level 422.

In one example, the battery power keeper state diagram 400 shows a reconstructed overvoltage waveform 425 in the overvoltage region 424. In one example, the reconstructed overvoltage waveform 425 is specified by a magnitude and a frequency. In one example, the reconstructed overvoltage waveform 425 is generated by a tracking/prediction circuit. In one example, the tracking/prediction circuit also generates a reconstructed undervoltage waveform, a reconstructed overcurrent waveform and a reconstructed undercurrent waveform (not shown).

In one example, the tracking/prediction circuit generates reconstructed waveforms for all power supplies, including batteries, in a system. In one example, the tracking/prediction circuit accumulates a count of violations and fault events beyond the nominal operational region for each power supply. In one example, the accumulated count of violations and fault events is stored by individual modules of the tracking/prediction circuit. In one example, the tracking/prediction circuit interpolates each reconstructed waveform to generate an interpolated reconstructed waveform.

In one example, the tracking/prediction circuit performs the following operations:
1. Execute an overcurrent and overvoltage tracker to capture occurrence statistics of a number of fault events, peak waveform levels and waveform frequency.
2. Execute an electrostatic discharge (ESD) current monitor for continuous ESD monitoring.
3. Execute a power supply glitch tracker to capture occurrence statistics of a number of fault events, peak waveform levels and waveform frequency.
4. Execute a power supply transmission line connection monitor for line voltage variation tolerance and continuity (e.g., +/−15% tolerance).
5. Execute a state of power keeper (SoP-K) neural network (NN) model to aggregate the above data.
6. Load a dump detection using the NN model.

In one example, dump detection relates to detection of a connectivity fault (e.g., a cable fault or damaged electrical component). For example, the connectivity fault may result in a higher impedance which restricts a large current flow. In one example, the connectivity fault may be detected by monitoring a voltage glitch or voltage spike which creates an overvoltage condition.

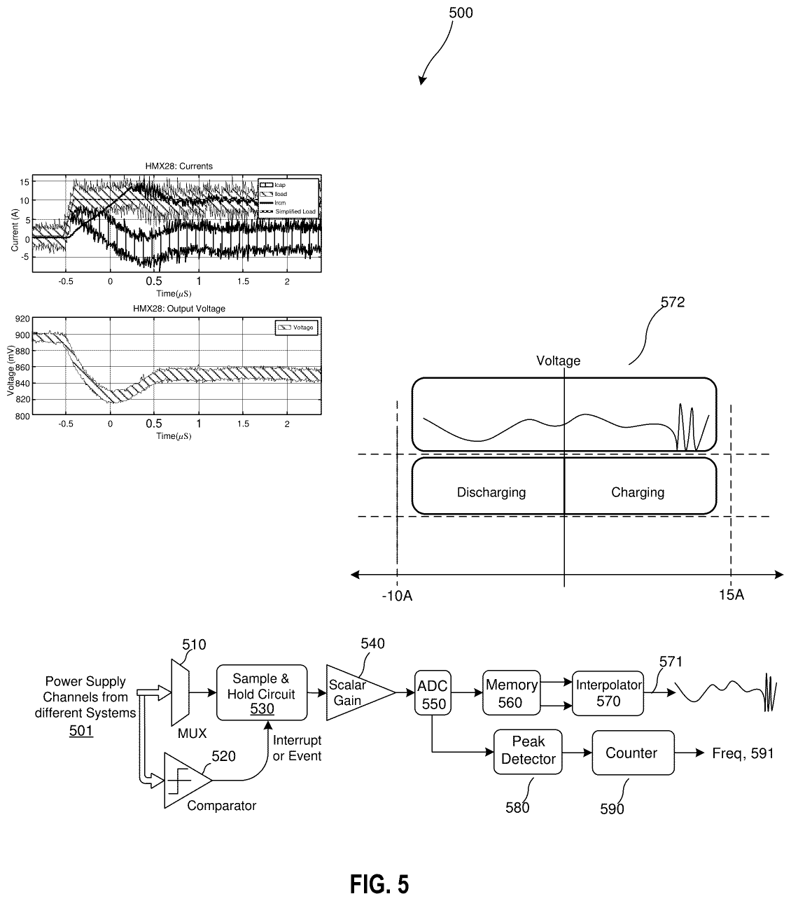

FIG. 5 illustrates an example mixed signal/digital overvoltage tracker circuit 500. In one example, a plurality of power supply channels 501 from different subsystems are provided as input to the mixed signal/digital overvoltage tracker circuit 500. In one example, the plurality of power supply channels 501 is delivered to an input of a multiplexer (mux) 510 and to an input of a comparator 520. In one example, the multiplexer 510 systematically selects one of the plurality of power supply channels 501 as an active input at a given time to be fed to a sample and hold circuit 530. In one example, the sample and hold circuit 530 is activated by an output of the comparator 520. That is, the sample and hold circuit 530 is active if the output of the comparator 520 generates an indicated event. In one example, the indicated event is an overvoltage event, an undervoltage event, an overcurrent event or an undercurrent event. In one example, the indicated event is a trigger signal used for activation of a device. Otherwise, the sample and hold circuit 530 is not active and does not consume operational de power.

In one example, the sample and hold circuit 530 first samples the selected one power supply channel of the plurality of power supply channels to produce a channel sample value at a time determined by the indicated event (e.g., trigger signal) from the output of the comparator 520. One skilled in the art would understand that the term “produce” as used in the present disclosure is synonymous with the term “generate”.

Next, the sample and hold circuit 530 holds the channel sample value over a period of time. In one example, the held channel sample value is next scaled by a scalar gain amplifier 540. In one example, the scaling is performed to match the held channel sample value to an analog to digital converter (ADC) input voltage range. In one example, the scaling is performed such that a maximum held channel sample value is less than an ADC saturation voltage. In one example, the scalar gain amplifier 540 may be alternatively located in front of the multiplexer 510, depending on the amplitude of the plurality of power supply channels 501.

In one example, the scaled channel sample value is sent as input to an ADC 550 for conversion to a digital channel sample. In one example, the digital channel sample is quantized to N bits, where N is an integer. In one example, the quantization is selected to provide a specified dynamic range for the scaled channel sample value.

In one example, the ADC 550 provides a digital channel sample output to a memory 560 and to a peak detector 580. In one example, the memory 560 temporarily stores a plurality of digital channel sample outputs and sends the plurality of digital channel sample outputs to an interpolator 570. In one example, the interpolator 570 produces an interpolated channel waveform 571 based on the plurality of digital channel sample outputs.

In one example, the peak detector 580 detects maxima of the plurality of digital channel sample outputs and sends the maxima to a counter 590. In one example, the counter 590 counts the maxima over a defined time period and provides a frequency estimate 591 based on the count. In one example, a portion of the mixed signal/digital overvoltage tracker circuit 500 is in an always ON power domain. In one example, an event or interrupt-based trigger for power up of standby circuitry is another feature of the mixed signal/digital overvoltage tracker circuit 500.

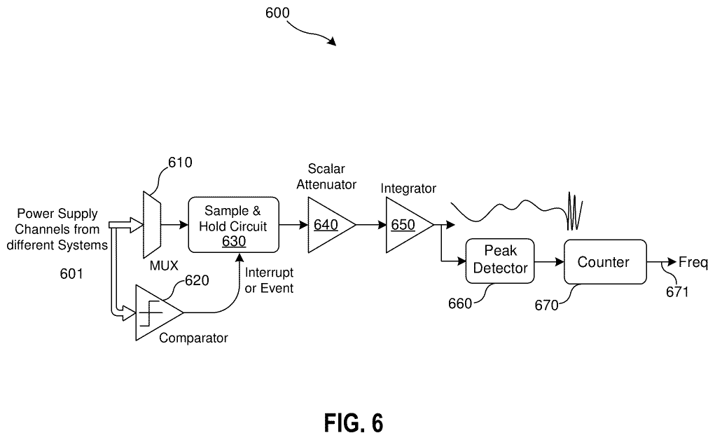

FIG. 6 illustrates an example analog overvoltage tracker circuit 600. In one example, a plurality of power supply channels 601 from different subsystems are provided as input to the analog overvoltage tracker circuit 600. In one example, the plurality of power supply channels 601 is delivered to an input of a multiplexer (mux) 610 and to an input of a comparator 620. In one example, the multiplexer 610 systematically selects one of the plurality of power supply channels 601 as an active input at a given time to be fed to a sample and hold circuit 630. In one example, the sample and hold circuit 630 is activated by an output of the comparator 620. That is, the sample and hold circuit 630 is active if the output of the comparator 620 generates an indicated event. In one example, the indicated event is an overvoltage event, an undervoltage event, an overcurrent event or an undercurrent event. In one example, the indicated event is a trigger signal used for activation of a device. Otherwise, the sample and hold circuit 630 is not active and does not consume operational dc power.

In one example, the sample and hold circuit 630 first samples the selected one power supply channel of the plurality of power supply channels to produce a channel sample value at a time determined by the indicated event (e.g., trigger signal) from the output of the comparator 620. Next, the sample and hold circuit 630 holds the channel sample value over a period of time. In one example, the held channel sample value is next scaled by a scalar attenuator 640. In one example, the scaling is performed to match the held channel sample value to an integrator input voltage range. In one example, the scaling is performed such that a maximum held channel sample value is less than an integrator saturation voltage. In one example, the scalar attenuator 640 may be alternatively located in front of the multiplexer 610, depending on the amplitude of the plurality of power supply channels 601.

In one example, the scaled channel sample value is sent as input to an integrator 650 for accumulation to an accumulated channel sample. In one example, the accumulated channel sample may be used to estimate an accumulated channel waveform.

In one example, the integrator 650 provides an accumulated channel sample output to a peak detector 660. In one example, the peak detector 660 detects maxima of the accumulated channel sample output and sends the maxima to a counter 670. In one example, the counter 670 counts the maxima over a defined time period and provides a frequency estimate 671 based on the count. In one example, a portion of the analog overvoltage tracker circuit 600 is in an always ON power domain. In one example, an event or interrupt based trigger for power up of standby circuitry is another feature of the analog overvoltage tracker circuit 600.

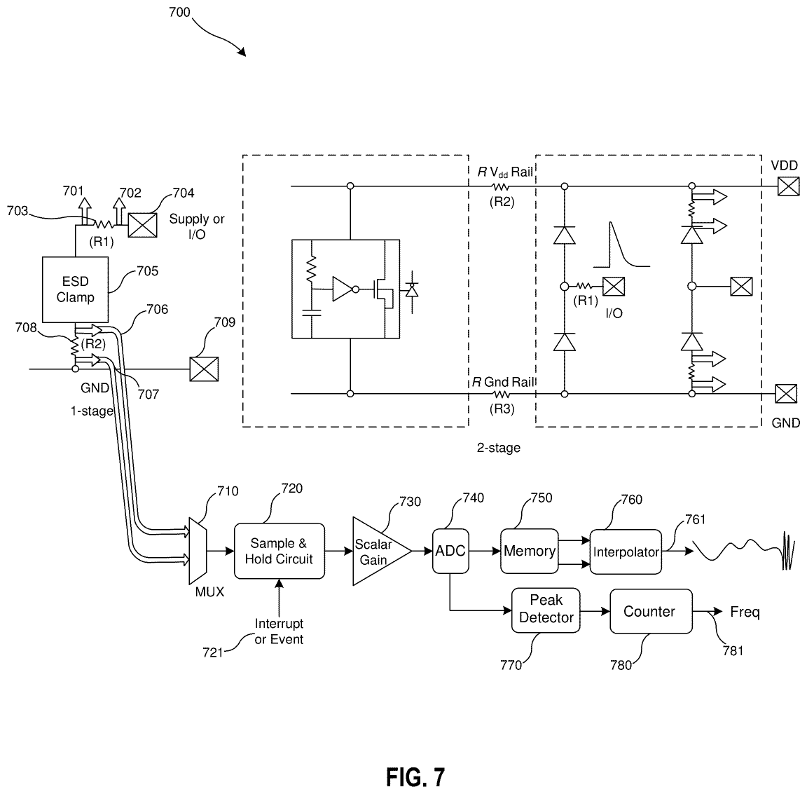

FIG. 7 illustrates an example electrostatic discharge (ESD)/clamp circuit 700. In one example, the ESD/clamp circuit 700 is used to detect ESD events. In one example, the ESD/clamp circuit 700 is a primary protection mechanism for electrostatic transients or any power related glitches. In one example, the ESD/clamp circuit 700 may be used to monitor non-ESD events as well by monitoring voltage or current for anomalous behavior (e.g., non-ESD events which are less severe than ESD events, but still problematic).

In one example, the ESD/clamp circuit 700 includes a first voltage input 701 and a second voltage input 702. In one example, the first voltage input 701 and the second voltage input 702 are coupled to two terminals of a first resistor R1 703, where the second voltage input 702 is tied to a supply voltage 704. In one example, the first voltage input 701 is coupled to a first terminal of an ESD clamp 705. In one example, a first voltage output 706 is coupled to a second terminal of the ESD clamp 705 and a second voltage output 707 is tied to ground 709. In one example, the first voltage output 706 and the second voltage output 707 are coupled to two terminals of a second resistor R2 708.

In one example, the first voltage output 706 and the second voltage output 707 are coupled as inputs to a multiplexer 710. In one example, an output of the multiplexer 710 is coupled to an input of a sample and hold circuit 720 which is triggered by an interrupt or event 721. In one example, an output of the sample and hold circuit 720 is coupled to an input of a scalar gain amplifier 730 to produce a scaled channel sample. In one example, the scaling is performed to match the channel sample value to an analog to digital converter (ADC) input voltage range. In one example, the scaling is performed such that a maximum scaled channel sample value is less than an ADC saturation voltage. In one example, the scalar gain amplifier 730 may be alternatively located in front of the multiplexer 710, depending on the amplitude of the plurality of power supply channels 701.

In one example, the scaled channel sample value is sent as input to an ADC 740 for conversion to a digital channel sample. In one example, the digital channel sample is quantized to N bits, where N is an integer. In one example, the quantization is selected to provide a specified dynamic range for the scaled channel sample value.

In one example, the ADC 740 provides a digital channel sample output to a memory 750 and to a peak detector 770. In one example, the memory 750 temporarily stores a plurality of digital channel sample outputs and sends the plurality of digital channel sample outputs to an interpolator 760. In one example, the interpolator 760 produces an interpolated channel waveform 761 based on the plurality of digital channel sample outputs.

In one example, the peak detector 770 detects maxima of the plurality of digital channel sample outputs and sends the maxima to a counter 780. In one example, the counter 780 counts the maxima over a defined time period and provides a frequency estimate 781 based on the count.

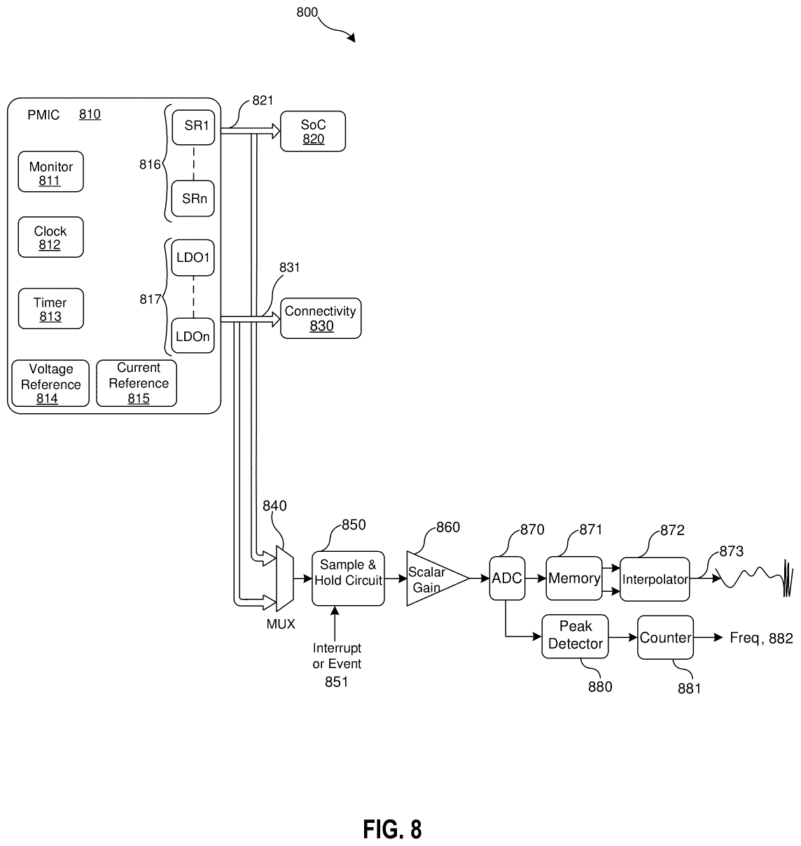

FIG. 8 illustrates an example power state management system 800. In one example, the power state management system 800 includes a power management integrated circuit (PMIC) 810, a system on a chip (SOC) 820 and a connectivity subsystem 830. In one example, an event tracker circuit may be included in the PMIC 810 or in the SOC 820 and may be in an always ON power domain. In one example, the event tracker circuit is triggered by one sensor of a plurality of sensors upon occurrence of an indicated event. In one example, the indicated event is an overvoltage event, an undervoltage event, an overcurrent event or an undercurrent event. In one example, the event tracker circuit allows low average power operation due to a low duty cycle of indicated events. In one example, generation of an outlier waveform may be used for diagnostics.

In one example, the PMIC 810 includes a monitor subsystem 811, a clock subsystem 812, a timer subsystem 813, a voltage reference 814, a current reference 815, a plurality of switching regulator (SR) interfaces 816 and a plurality of low dropout (LDO) interfaces 817. For example, the plurality of switching regulator (SR) interfaces 816 and the plurality of low dropout (LDO) interfaces 817 may supply dc power to attached loads.

In one example, the SOC 820 receives a SOC power supply input 821 from the PMIC 810. In one example, the connectivity subsystem 830 receives a connectivity power supply input 831 from the PMIC 810. In one example, the SOC power supply input 821 and the connectivity power supply input are sent to a multiplexer 840. In one example, an output of the multiplexer 840 is coupled to an input of a sample and hold circuit 850 which is triggered by an interrupt or event 851. In one example, an output of the sample and hold circuit 850 is coupled to an input of a scalar gain amplifier 860 to produce a scaled channel sample. In one example, the scaling is performed to match the channel sample value to an analog to digital converter (ADC) input voltage range. In one example, the scaling is performed such that a maximum scaled channel sample value is less than an ADC saturation voltage. In one example, the scalar gain amplifier 860 may be alternatively located in front of the multiplexer 840, depending on the amplitude of the SOC power supply input 821 and the connectivity power supply input 831.

In one example, the scaled channel sample value is sent as input to an ADC 870 for conversion to a digital channel sample. In one example, the digital channel sample is quantized to N bits, where N is an integer. In one example, the quantization is selected to provide a specified dynamic range for the scaled channel sample value.

In one example, the ADC 870 provides a digital channel sample output to a memory 871 and to a peak detector 880. In one example, the memory 871 temporarily stores a plurality of digital channel sample outputs and sends the plurality of digital channel sample outputs to an interpolator 872. In one example, the interpolator 872 produces an interpolated channel waveform 873 based on the plurality of digital channel sample outputs.

In one example, the peak detector 880 detects maxima of the plurality of digital channel sample outputs and sends the maxima to a counter 881. In one example, the counter 881 counts the maxima over a defined time period and provides a frequency estimate 882 based on the count. In one example, when a processor or any other subsystem commences operation after a sleep period, a voltage transient (e.g., a temporary load attack) may occur on a power supply line. In one example, the voltage transient may be a normal turn-on operational characteristic.

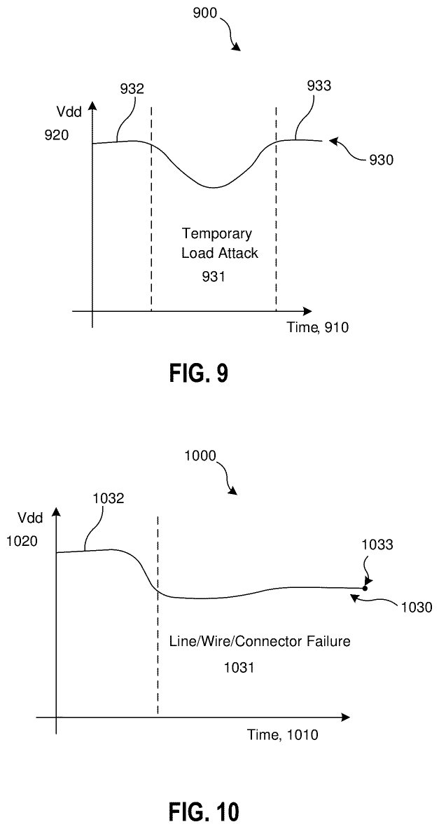

FIG. 9 illustrates an example voltage transient graph 900 during a temporary load attack. For example, the example voltage transient graph 900 includes a horizontal axis as a time axis 910, a vertical axis as a power supply voltage axis 920 and a power supply voltage trace 930 shown as a function of time. In one example, during a temporary load attack period 931, the power supply voltage trace 930 shows a voltage transient where the power supply voltage drops below an initial nominal voltage level 932 shown at the beginning of the power supply voltage trace 930 and then recovers to a final nominal voltage level 933 shown at the end of the power supply voltage trace 930.

In one example, when a processor or any other subsystem commences operation after a sleep period, a voltage fault (e.g., a line/wire/connector failure) may occur on a power supply line. In one example, the voltage fault, which shows no recovery from a transient characteristic may be due to a line or connector failure or due to an impedance increase.

FIG. 10 illustrates an example voltage fault graph 1000 during a voltage fault. In one example, the voltage fault graph 1000 includes a horizontal axis as a time axis 1010, a vertical axis as a power supply voltage axis 1020 and a power supply voltage trace 1030 shown as a function of time. In one example, during a voltage fault 1031, the power supply voltage trace 1030 shows a voltage transient where the power supply voltage drops below an initial nominal voltage level 1032 shown at the beginning of the power supply voltage trace 1030 and then settles to a final faulted voltage level 1033 shown at the end of the power supply voltage trace 1030. In one example, the final faulted voltage level 1033 is less than the initial nominal voltage level 1032. In one example, the power supply voltage trace 1030 behavior during a voltage fault 1031 indicates presence of a line or connector failure or an impedance increase. In one example, an event tracker circuit may monitor and report a voltage fault such as that illustrated in FIG. 10.

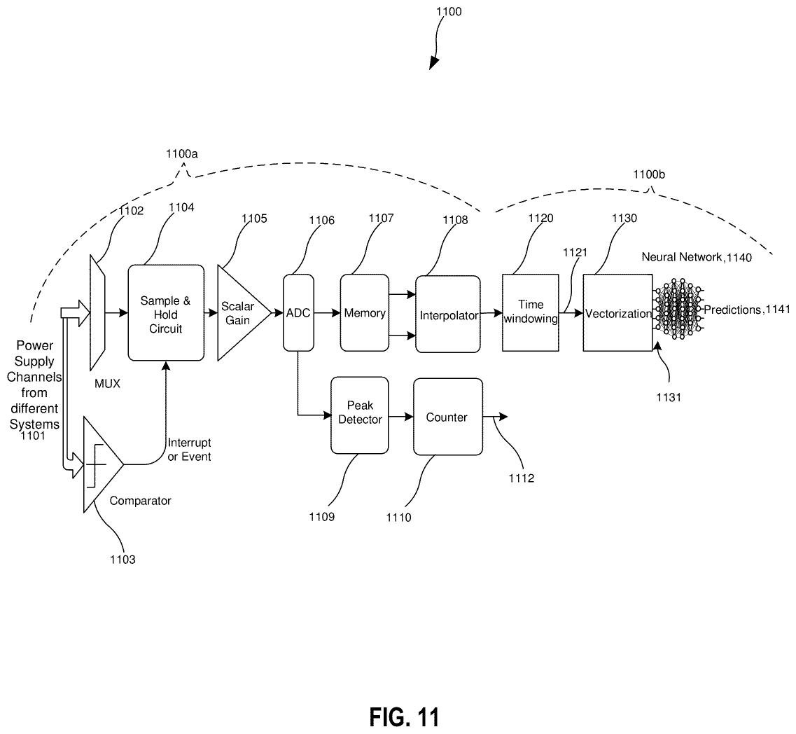

FIG. 11 illustrates an example system 1100 with an event tracker circuit 1100a and a state of power keeper (SoP-K) neural network (NN) module 1100b. In one example, the SoP-K neural network module 1100b is part of a power state management and diagnostics system. In one example, the event tracker circuit 1100a is part of tracking/prediction circuit. In one example, the event tracker circuit 1100a accepts a plurality of power supply channels 1101 and produces an interpolated channel waveform 1111 and a frequency estimate 1112 using a multiplexer 1102, comparator 1103, sample and hold circuit 1104, scalar gain amplifier 1105, ADC 1106, memory 1107, interpolator 1108, peak detector 1109 and counter 1110.

In one example, the interpolated channel waveform 1111 is sent as an input to a time windowing module 1120. In one example, the time windowing module 1120 truncates the interpolated channel waveform 1111 to a defined time duration T to produce a windowed channel waveform 1121. In one example, the interpolated channel waveform 1111 is sent as an input to an apodizer wherein the apodizer truncates the interpolated channel waveform 1111 to a defined time duration T to produce a windowed channel waveform 1121. In one example, the apodizer applies weighted time windowing.

In one example, the windowed channel waveform 1121 is sent as an input to a vectorization module 1130. In one example, the vectorization module 1130 aggregates scalar (i.e., single dimensional) data to produce vectorized (i.e., multidimensional) data to produce a vectorized channel waveform 1131.

In one example, the vectorized channel waveform 1131 is sent as an input to a neural network (NN) 1140 for neural network processing. In one example, a data augmentation module or a feature extraction module may be included after the vectorization module 1130 for data enhancement. In one example, the NN 1140 produces a plurality of power supply predictions 1141 based on the interpolated channel waveform 1111.

In one example, the NN 1140 may be a shallow neural network with minimal layers. In one example, the NN 1140 may be a recursive NN, a deep NN, a convolutional NN or a generative NN. In one example, the type of neural network may be selected based on computational resources available.

In one example, a neural network includes a plurality of layers (i.e., sections) with an input layer, an output layer and one or more intermediate layers. In one example, the input layer includes a plurality of input nodes and the output layer includes a plurality of output nodes. For example, each output node is specified by an interconnection structure from the plurality of input nodes to the plurality of output nodes. In one example, different interconnection structures between the input layer and the output layer may be used in a neural network.

For example, a recursive neural network employs a recursive (i.e., repeating) interconnection structure in the one or more intermediate layers. For example, a deep neural network employs several intermediate layers between the input layer and the output layer. For example, a convolutional neural network employs a superposition interconnection structure where each output node is defined by a combination of a subset of the plurality of input nodes. For example, a generative neural network employs a generator network to generate a plurality of internal points and a discriminator network to determine differences from the plurality of internal points and a plurality of actual data.

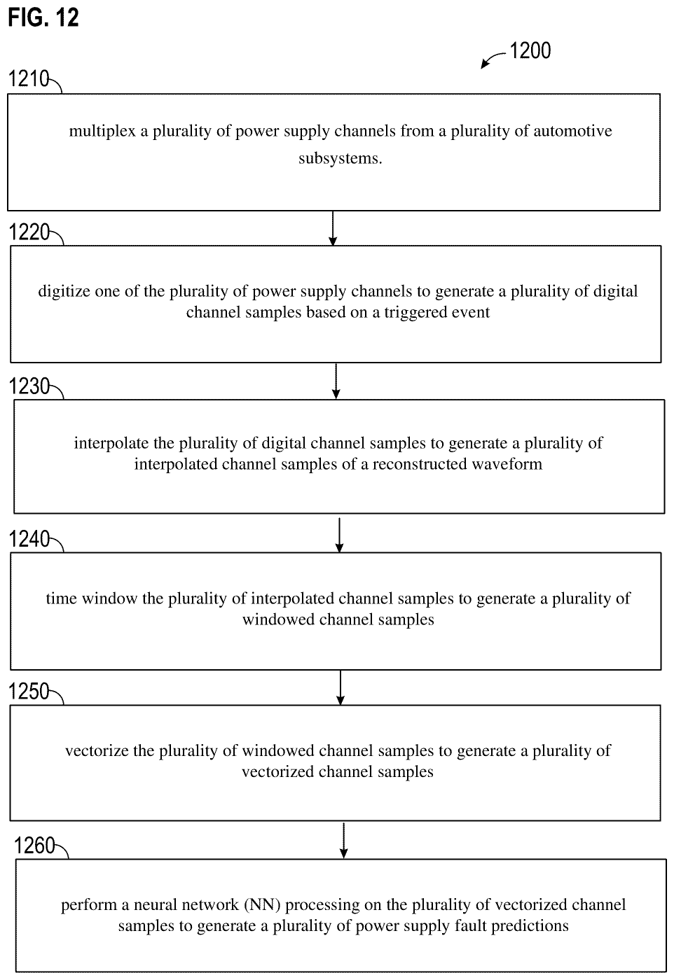

FIG. 12 illustrates an example flow diagram 1200 for implementing power state management and diagnostics. In block 1210, multiplex a plurality of power supply channels from a plurality of automotive subsystems. In one example, a plurality of power supply channels from a plurality of automotive subsystems is multiplexed. In one example, the multiplexing accepts the plurality of power supply channels using time division multiplexing (TDM). In one example, the step in block 1210 is performed by one of the following: a multiplexer, a combinatorial digital logic circuitry, or a sequential digital logic circuitry.

In block 1220, digitize one power supply channel of the plurality of power supply channels to generate a plurality of digital channel samples based on a triggered event. In one example, one power supply channel of the plurality of power supply channels is digitized to generate a plurality of digital channel samples based on a triggered event. In one example, the triggered event is an overvoltage event, an undervoltage event, an overcurrent event or an undercurrent event. In one example, the triggered event is generated by comparing the one power supply channel to a predetermined voltage threshold or a predetermined current threshold. In one example, the digitization includes sampling in time. In one example, the digitization includes quantization in amplitude. In one example, the quantization in amplitude includes a scaling in amplitude. In one example, the scaling is performed such that a maximum held channel sample value is less than an ADC saturation voltage. In one example, the step in block 1220 is performed by one of the following: a sample and hold circuit, an analog to digital converter (ADC), a digitizer, a quantizer, or a source encoder.

In block 1230, interpolate the plurality of digital channel samples to generate a plurality of interpolated channel samples of a reconstructed waveform. In one example, the plurality of digital channel samples is interpolated to generate a plurality of interpolated channel samples of a reconstructed waveform. In one example, the interpolation uses linear interpolation. In one example, the interpolation uses nonlinear interpolation. In one example, the reconstructed waveform includes an estimated frequency based on a counter measurement of detected peaks of the plurality of digital channel samples. In one example, the reconstructed waveform includes an estimated peak amplitude level. In one example, the step in block 1230 is performed by one of the following: interpolator, a filter, a convolutional circuit, a predictor, or a smoother.

In block 1240, time window the plurality of interpolated channel samples to generate a plurality of windowed channel samples. In one example, the plurality of interpolated channel samples is time windowed to generate a plurality of windowed channel samples. In one example, time windowing truncates the plurality of interpolated channel samples to a defined time duration T. In one example, the time windowing includes tapering (i.e., apodization) to smooth the plurality of windowed channel samples. In one example, the tapering may be a raised cosine taper, a Gaussian taper, a binomial taper, etc. In one example, the step in block 1240 is performed by one of the following: a time windowing module, a truncator, an apodizer, a taperer, a amplitude shaper, or a digital gate circuit.

In block 1250, vectorize the plurality of windowed channel samples to generate a plurality of vectorized channel samples. In one example, the plurality of windowed channel samples is vectorized to generate a plurality of vectorized channel samples. In one example, the vectorization aggregates scalar (i.e., single dimensional) data to generate vectorized (i.e., multidimensional) data. In one example, the step in block 1250 is performed by one of the following: a vectorization module, an aggregator, a dimensional scaler, or a tensorizer.

In block 1260, perform a neural network (NN) processing on the plurality of vectorized channel samples to generate a plurality of power supply fault predictions. In one example, a neural network (NN) processing is performed on the plurality of vectorized channel samples to generate a plurality of power supply fault predictions. In one example, the plurality of power supply fault predictions may include prediction of power supply overvoltage or undervoltage, prediction of power supply overcurrent or undercurrent, prediction of power supply temperature violations, prediction of power supply battery depth of discharge (DoD) violations. In one example, the plurality of power supply fault predictions may include electrostatic discharge (ESD) events, power supply glitches, power supply line faults, etc. In one example, the plurality of power supply fault predictions includes occurrence statistics of fault events in the power supply. In one example, the NN processing may be recursive NN processing, deep NN processing, convolutional NN processing or generative NN processing. In one example, the step in block 1260 is performed by one of the following: a neural network (NN), a graphics processing unit, a digital signal processor, a vector processor or a multicore processing engine.

In one aspect, one or more of the steps for providing power state management and diagnostics in FIG. 12 may be executed by one or more processors which may include hardware, software, firmware, etc. The one or more processors, for example, may be used to execute software or firmware needed to perform the steps in the flow diagram of FIG. 12. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
a neural network (NN) module configured to process a plurality of vectorized channel samples and to generate a plurality of power supply fault predictions; and
a vectorization module coupled to the NN module, the vectorization module configured to vectorize a plurality of windowed channel samples and to generate the plurality of vectorized channel samples.

2. The apparatus of claim 1, further comprising an apodizer coupled to the vectorization module, the apodizer configured to time window a plurality of interpolated channel samples and to generate the plurality of windowed channel samples.

3. The apparatus of claim 2, wherein the time window is weighted.

4. The apparatus of claim 2, further comprising an interpolator coupled to the apodizer, the interpolator configured to interpolate a plurality of digital channel samples and to generate the plurality of interpolated channel samples of a reconstructed waveform.

5. The apparatus of claim 4, further comprising an analog to digital converter (ADC) coupled to the interpolator, the ADC configured to digitize one of a plurality of power supply channels and to generate the plurality of digital channel samples based on a triggered event.

6. The apparatus of claim 5, further comprising a multiplexer coupled to the ADC, the multiplexer configured to multiplex the plurality of power supply channels from a plurality of automotive subsystems.

7. A method comprising:
performing a neural network (NN) processing on a plurality of vectorized channel samples to generate a plurality of power supply fault predictions; and
vectorizing a plurality of windowed channel samples to generate the plurality of vectorized channel samples.

8. The method of claim 7, wherein the plurality of power supply fault predictions includes one or more of the following: a prediction of power supply overvoltage, a prediction of power supply undervoltage, a prediction of power supply overcurrent, a prediction of power supply undercurrent, a prediction of power supply temperature violation, or a prediction of power supply battery depth of discharge (DoD) violation.

9. The method of claim 7, wherein the plurality of power supply fault predictions includes one or more of the following: an electrostatic discharge (ESD) event, a power supply glitch, or a power supply line fault.

10. The method of claim 7, wherein the plurality of power supply fault predictions includes at least one occurrence statistic of fault events in a power supply.

11. The method of claim 7, further comprising time windowing a plurality of interpolated channel samples to generate the plurality of windowed channel samples.

12. The method of claim 11, further comprising interpolating a plurality of digital channel samples to generate the plurality of interpolated channel samples of a reconstructed waveform.

13. The method of claim 12, wherein the reconstructed waveform includes an estimated frequency based on a counter measurement of one or more detected peaks of the plurality of digital channel samples.

14. The method of claim 12, wherein the reconstructed waveform includes an estimated peak amplitude level.

15. The method of claim 12, further comprising digitizing one of a plurality of power supply channels to generate the plurality of digital channel samples based on a triggered event.

16. The method of claim 15, further comprising multiplexing the plurality of power supply channels from a plurality of electronic subsystems.

17. The method of claim 16, wherein the plurality of electronic subsystems is a plurality of automotive subsystems.

18. A non-transitory computer-readable medium storing computer executable code, operable on a device comprising at least one processor and at least one memory coupled to the at least one processor, wherein the at least one processor is configured to implement power state management and diagnostics, the computer executable code comprising:
instructions for causing a computer to perform a neural network (NN) processing on a plurality of vectorized channel samples;
instructions for causing the computer to generate a plurality of power supply fault predictions;
instructions for causing the computer to vectorize a plurality of windowed channel samples; and
instructions for causing the computer to generate the plurality of vectorized channel samples.

19. The non-transitory computer-readable medium of claim 18, further comprising:
instructions for causing the computer to time window a plurality of interpolated channel samples;
instructions for causing the computer to generate the plurality of windowed channel samples;
instructions for causing the computer to interpolate a plurality of digital channel samples; and
instructions for causing the computer to generate the plurality of interpolated channel samples of a reconstructed waveform.

20. The non-transitory computer-readable medium of claim 19, further comprising:
instructions for causing the computer to digitize one of a plurality of power supply channels;
instructions for causing the computer to generate the plurality of digital channel samples based on a triggered event; and
instructions for causing the computer to multiplex the plurality of power supply channels from a plurality of electronic subsystems.
